(19) United States
(12) Patent Application Publication
(10) Pub. No.: US 2010/0239242 A1
(43) Pub. Date: Sep. 23, 2010

(54) SAFEGUARD APPARATUS FOR COVERING CAMERA LENS

(75) Inventors: SUNG HYUN KA, GUNPO-SI (KR); MYOUNG IL CHAE, HWASEONG-SI (KR); YONG HEE CHOI, SEOUL (KR)

Correspondence Address: KNOBBE MARTENS OLSON & BEAR LLP, 2040 MAIN STREET, FOURTEENTH FLOOR, IRVINE, CA, 92614, US

(73) Assignee: AMPHENOL PHOENIX CO., LTD., Hwaseong-si (KR)

(21) Appl. No.: 12/770,664

(22) Filed: Apr. 29, 2010

Related U.S. Application Data
(63) Continuation of application No. PCT/KR2008/006388, filed on Oct. 29, 2008.

(30) Foreign Application Priority Data
Oct. 30, 2007 (KR) 10-2007-0109783

(51) Int. Cl. G03B 17/00

(52) U.S. Cl. 396/448

(57) ABSTRACT

A handheld electronic device includes a housing, and a camera lens. The housing has a hole, and a camera lens is accommodated within the housing and exposed through the hole. The device includes a slidable panel and a retractable panel. The slidable panel is slidable relative to the housing between a covering position and a uncovering position. The camera lens is covered by the slidable panel when the slidable panel is at the covering position. The camera lens is uncovered when the slidable panel is at uncovering position. The retractable panel is movable relative to the housing between a retracted position and an unretracted position. The device further includes a mechanism configured to move the retractable panel from the unretracted position to the retracted position as the slidable panel slides from the covering position to the uncovering position.

### CROSS-REFERENCE TO RELATED PATENT APPLICATIONS

This application is a continuation application under 35 U.S.C. §365(c) of International Application No. PCT/KR2008/006388, filed Oct. 29, 2008 designating the United States. International Application PCT/KR2008/006388 was published in English as WO2009/057949 A1 on May 7, 2009. This application further claims the benefit of the earlier filing date under 35 U.S.C. §365(b) of Korean Patent Application No. 10-2007-0109783 filed Oct. 30, 2007. This application incorporates herein by reference the International Application No. PCT/KR2008/006388 including the International Publication No. WO2009/057949 A1 and the Korean Patent Application No. 10-2007-0109783 in their entirety.

### BACKGROUND

1. Field

The present disclosure relates to a safeguard apparatus for covering a camera lens.

2. Discussion of Related Technology

In recently years, as the expense for use of a mobile communication terminal (hereinafter, referred to as ‘mobile phone’) becomes cheaper due to advance in communication technologies and high quality communication is possible even in a traveling vehicle due to enhancement of communication quality, mobile phones are being popularly used. Moreover, multi-functional mobile phones are being distributed and used so that telecommunications companies can satisfy various demands of consumers.

The commercialized mobile phones generally perform various functions such as playing of games, search of the internet, transmission and reception of e-mails, payment for goods, as well as voice communication, and recently, the function of video communication for transmitting a photographed image to the counterpart using cameras embedded in mobile phones is added to the mobile phones.

The camera including a lens mounted to a mobile phone has only a window UV-coated for protection of a camera and shielding from UV rays. Accordingly, as the camera lens are usually exposed to the outside, the surface of the lens is contaminated by foreign substances such as dust when the mobile phone is being carried and used, or is damaged by friction or an impact from the outside.

In consideration of the above-mentioned problems, cover apparatus for protection of lenses of cameras embedded in mobile phones are being continuously developed. As an example, Korean Patent No. 10-649734 discloses a mobile phone having a lens protecting cover that comprises a hole formed at the sheath of the mobile phone so that an image can be photographed through the lens of a camera module, a cover member disposed between the camera module and the hole, and one end of which is rotatably mounted to the inner surface of the sheath of the mobile phone and the opposite end of which has a knob, and a window member mounted to a portion of the cover member and made of a light transmitting material so that the lens of the camera module can photograph an image through the hole when the window member coincides with the hole. The hole can be closed by rotating the cover member or an image can be photographed by the camera module when the window member coincides with the hole.

However, the camera lens protecting apparatus has a knob protruding to the outside from the cover member, so the knob may be easily damaged. Moreover, the damage to the knob makes the protection apparatus useless.

The foregoing discussion in the background section is to provide general background information, and does not constitute an admission of prior art.

### SUMMARY

One aspect of the invention provides a handheld electronic device. The device can comprise: a housing comprising a hole; a camera lens accommodated within the housing and exposed through the hole; a slidable panel slidable relative to the housing between a covering position and a uncovering position, wherein the camera lens is covered by the slidable panel when the slidable panel is at the covering position, wherein the camera lens is uncovered when the slidable panel is at uncovering position; a retractable panel movable relative to the housing between a retracted position and an unretracted position; and a mechanism configured to move the retractable panel from the unretracted position to the retracted position as the slidable panel slides from the covering position to the uncovering position.

In the foregoing device, the retractable panel is at its unretracted position when the slidable panel may be at its covering position. When the slidable panel is at its covering position and the retractable panel is at its unretracted position, the slidable panel and retractable panel may be next to each other at about the same level from the housing. The retractable panel may be at its retracted position when the slidable panel is at its uncovering position. When the slidable panel is at its uncovering position and the retractable panel is at its retracted position, the slidable panel and retractable panel may be next to each other at different levels from the housing. The slidable panel may cover the retractable panel when the slidable panel is at its uncovering position. The retractable panel is not covered by the slidable panel when the slidable panel is at its covering position.

Still in the foregoing device, the mechanism may comprise a lever configured to move between a first position and a second position, wherein the retractable panel may be at its retracted position when the lever stays at the second position. The slidable panel may be configured to move the lever from the first position to the second position as the slidable panel slides in an uncovering direction that is from the covering position to the uncovering position. The lever may be configured to reach the second position before the slidable panel reaches the uncovering position during its sliding in the uncovering direction. Once the lever has reached the second position, the slidable panel causes the lever to stay at its second position while the slidable panel is sliding in the uncovering direction and when the slidable panel stays at its uncovering position. The lever may be configured to move from the second position to the first position as the slidable panel slides in a covering direction that is from the uncovering position to the covering position.

Yet in the foregoing device, the sliding panel may be configured to cause the lever to stay at its second position while the slidable panel is sliding in the covering direction until after the slidable panel has reached a predetermined position located between its covering position and its uncovering position. The mechanism may comprise a spring that biases the lever toward its first position, wherein once the sliding panel has passed the predetermined position during its sliding in the covering direction, the lever is configured to begin moving from its second position to the first position. With action of the spring, the lever may be further configured to push the sliding panel toward the covering position after the sliding panel has passed the predetermined position.

Further in the foregoing device, the retractable panel may be configured to reach its retracted position before the slidable panel reaches its uncovering position. The mechanism may be further configured to move the retractable panel from the retracted position to the unretracted position as the slidable panel slides from the uncovering position to the covering position. The retractable panel may be configured to stay at its retracted position until after the slidable panel has reached a predetermined position located between its covering position and its uncovering position.

Another aspect of the invention provides a method of operating a handheld electronic device. The method comprises: providing the foregoing device, in which the slidable panel is at its covering position, and the retractable panel is at its unretracted position; and sliding the slidable panel toward the uncovering position, which causes the retractable panel to move from the unretracted position toward the retracted position.

In the foregoing method, the retractable panel may reach the retracted position before the slidable panel reaches the uncovering position, wherein the retractable panel may stay at its retracted position when the slidable panel stays at its uncovering position. The method may further comprise: sliding the slidable panel from the uncovering position toward the covering position, wherein the retractable panel stays at its retracted position before the slidable panel reaches a predetermined position between the uncovering position and the covering position; and further sliding the slidable panel to pass the predetermined position, which causes the retractable panel to move from the retracted position to the unretracted position, and further causes the slidable panel to spontaneously slide toward the covering position without external force to slide the slidable panel toward the covering direction.

Yet another aspect of the present invention provides a safeguard apparatus for a camera lens that can simply and easily open and close the camera lens embedded in a mobile phone in a slide manner.

In accordance with an aspect of the present invention, there is provided a safeguard apparatus for opening and closing a camera lens by sliding the camera lens and protecting the camera lens, comprising: a support body having a lens hole for exposing the camera lens; a cover member slidably mounted to the support member to open and close the camera lens exposed through the lens hole; a plate member movable upward and downward from the rear end of the support body to provide a resilient force to the cover when making contact with the cover member while the cover member is being slid; and a drive unit provided in a support frame to be operated by rotary links, ends of which are caught and rotated when the cover member is slid, so as to accommodate and automatically return the plate member.

Here, the support member includes an exposure plate having a lens hole for exposing the camera lens and fixing bars fixed to opposite sides thereof to fix the exposure plate to a case of the mobile phone. The cover member includes guide bars fixed to the fixing bars respectively, and a cover plate opposite sides of which are slidably inserted into the guide bars.

Extension pieces are formed on opposite side surfaces of the plate member, each extension piece has first and second connection holes for connecting the extension piece to the drive unit, a fixing hole for fixing a fixing pin of the drive unit is formed in the plate member between the first and second connection holes, and a downwardly inclined contact piece is formed at the front end of the plate member so as to softly move the cover member during slide of the cover member and to provide a resilient force when the cover member slides back to the original position and then makes contact with an end of the plate member.

A connection hole and a fixing hole are diagonally formed in each side surface of the support frame to connect the drive unit to the support frame, and first and second movement guide holes are formed on opposite side surfaces of the support frame so that the first and second connection holes of the connection pieces and the first and second connection links of the drive unit are connected to each other and the drive unit is moved forward inside the support frame when the plate member is inserted into the support frame.

The drive unit includes movable bars ends of which are connected to extension pieces of the plate member respectively so as to be moved on opposite inner surfaces of the support frame along first and second movement guide holes of the support frame, rotary link ends of which are rotatably connected to the front end of the movable bar and the opposite ends of which are rotatably connected to the support frame, and resilient members ends of which are connected to the extension pieces of the plate member and the opposite ends of which are connected to side surfaces of the support frame to provide a resilient force to the plate member and automatically return the plate member to the original position. The safeguard apparatus for a camera lens in accordance an embodiment can simply and easily open and close the camera lens embedded in a mobile phone in a slide manner.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view illustrating a safeguard apparatus for a camera lens according to one embodiment of the present invention;

FIG. 2 is a perspective view illustrating the safeguard apparatus of FIG. 1 from the bottom;

FIG. 3 is a perspective view illustrating the safeguard apparatus of FIG. 1 from the bottom before the operation of the safeguard apparatus;

FIG. 4 is a perspective view illustrating the safeguard apparatus of FIG. 1 from the bottom after the operation of the safeguard apparatus;

FIG. 5 is a side view illustrating the safeguard apparatus of FIG. 1 before the operation of the safeguard apparatus;

FIG. 6 is a side view illustrating the safeguard apparatus of FIG. 1 after the operation of the safeguard apparatus;

FIG. 7 is a perspective view illustrating a safeguard apparatus for a camera lens according to one embodiment of the present invention from the bottom;

FIG. 8 is an exploded perspective view illustrating an operation unit of the safeguard apparatus of FIG. 7;

FIG. 9 is a side view illustrating the safeguard apparatus of FIG. 7 before the operation of the safeguard apparatus;

FIG. 10 is a side view illustrating the safeguard apparatus of FIG. 7 after the operation of the safeguard apparatus;

FIG. 11 is a perspective view illustrating installation of an operation unit in a support frame of a safeguard apparatus for a camera lens according to one embodiment of the present invention;

FIG. 12 is an exploded perspective view illustrating the operation unit of FIG. 11;

FIG. 13 is a side view illustrating the safeguard apparatus of FIG. 11 before the operation of the safeguard apparatus; and

FIG. 14 is a side view illustrating the safeguard apparatus of FIG. 11 after the operation of the safeguard apparatus.

### DETAILED DESCRIPTION OF EMBODIMENTS

Hereinafter, embodiments of the present invention will be described in detail with reference to the accompanying drawings. It should be understood that the same reference numerals indicate the same elements or parts. In the following description of embodiments, persons of those skilled in the art will appreciate that the detailed description of the already known structure and operation and the certain details not related to the subject matter will be omitted in this detailed description so as not to obscure the relevant details of the present embodiment and for greater clarity.

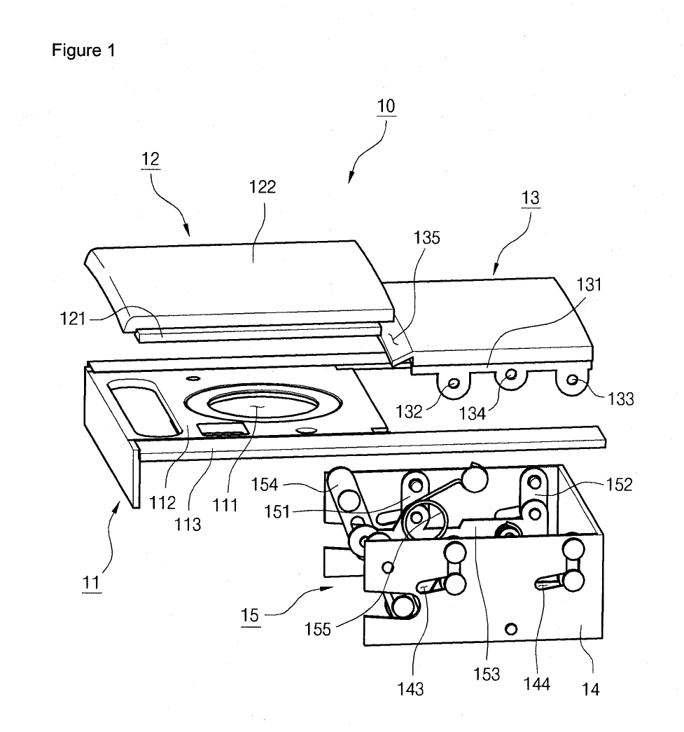

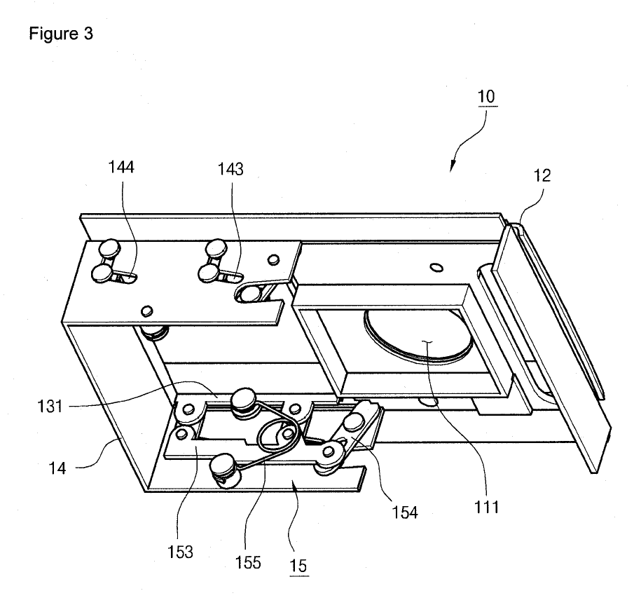

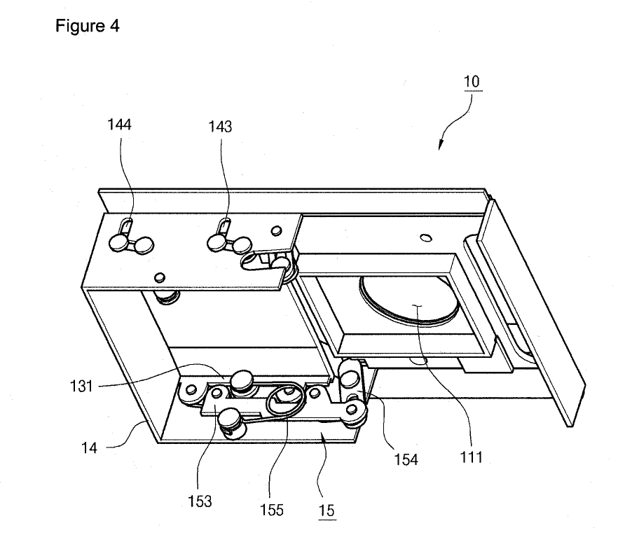

FIGS. 1 to 6 are views illustrating a safeguard apparatus for a camera lens according to one embodiment of the present invention. As illustrated, the safeguard apparatus 10 for a camera lens according to the embodiment of the present invention opens and closes a lens (not shown) of a camera embedded in a mobile phone by sliding the lens.

The safeguard apparatus 10 includes a support body 11 fixed to a case (not shown) of a mobile phone and having a lens hole 111 for exposing the lens of the camera, a cover member 12 slidably mounted to the support member 11 to open and close the lens exposed through the lens hole 111, a plate member 13 movable upward and downward from the rear end of the support body 11 to provide a resilient force to the cover 12 when making contact with the cover member 12 while the cover member 12 is being slid, and a drive unit 15 provided in the support frame 14 to be operated by a rotary link 154, one end of which is caught and rotated when the cover member 12 is slid, so as to accommodate and automatically return the plate member 13.

Hereinafter, the safeguard apparatus for a camera lens according to one embodiment of the present invention will be described in detail. As illustrated in FIG. 1, the support member 11 includes an exposure plate 112 having a lens hole 111 for exposing the camera lens at a central portion thereof, and fixing bars 113 fixed to opposite sides thereof to fix the exposure plate 112 to the case of the mobile phone and longer than the exposure plate 112.

The cover member 12 opens and closes the exposure hole 111 when it is slid upward and downward along the fixing bars 113. The cover member 12 includes guide bars 121 fixed to the fixing bars 113 respectively, and a cover plate 122 opposite sides of which are slidably inserted into the guide bars 121.

Here, guide grooves (reference numerals omitted) for accommodating opposite sides of the cover plate 122 are formed on facing surfaces of the guide bars 121, and guide bosses (reference numerals omitted) having cross-sections corresponding to the guide grooves are formed on opposite sides of the cover plate 122.

The plate member 13 is located at the lower end of the exposure plate 112, and the fixing bars 113 longer than the exposure plate 112 are located on opposite sides of the exposure plate 112. Extension pieces 131 bent in one direction are integrally formed on opposite side surfaces of the plate member 13. Each extension piece 131 has first and second connection holes 132 and 133 spaced apart from each other by a predetermined distance to connect the extension piece 131 to the drive unit 15, and a fixing hole 134 for fixing a fixing pin (reference numeral omitted) connected to resilient members 155 of the drive unit 15 between the first and second connection holes 132 and 133.

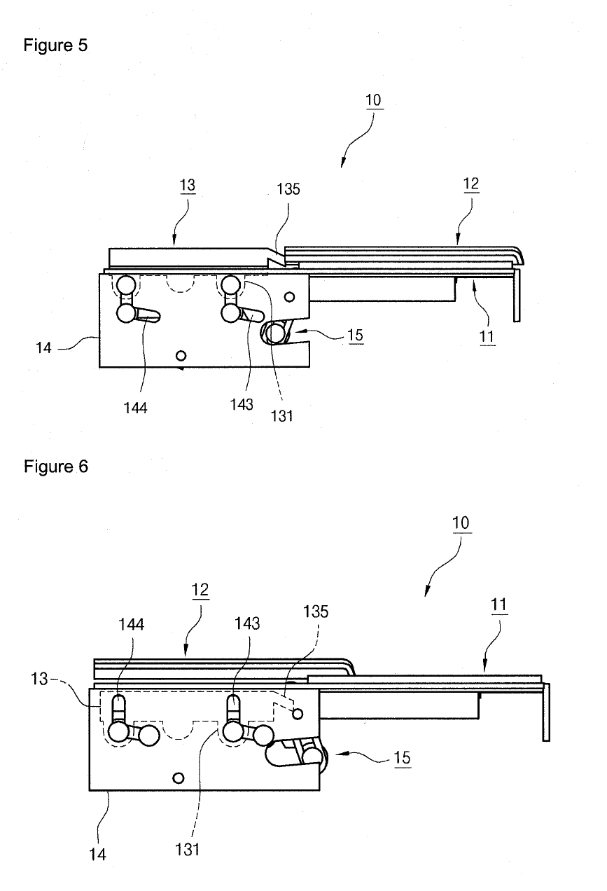

As illustrated in FIGS. 5 and 6, a downwardly inclined contact piece 135 is formed at one end of the plate member 13, i.e. at the front end of the plate member 13 close to the exposure plate 112 so as to softly move the cover member 12 during the slide of the cover member 12 and to provide a resilient force when the cover member 12 slides back to the original position and then makes contact with the end of the plate member 13.

The upper, lower, and front faces of the support frame 14 are opened to install the drive unit 15 and to insert and withdraw the plate member 13 connected to the drive unit 15 by the medium of pins passing through opposite side surfaces of the support frame 14, i.e. the first and second connection holes 132 and 133 of the connection pieces 131.

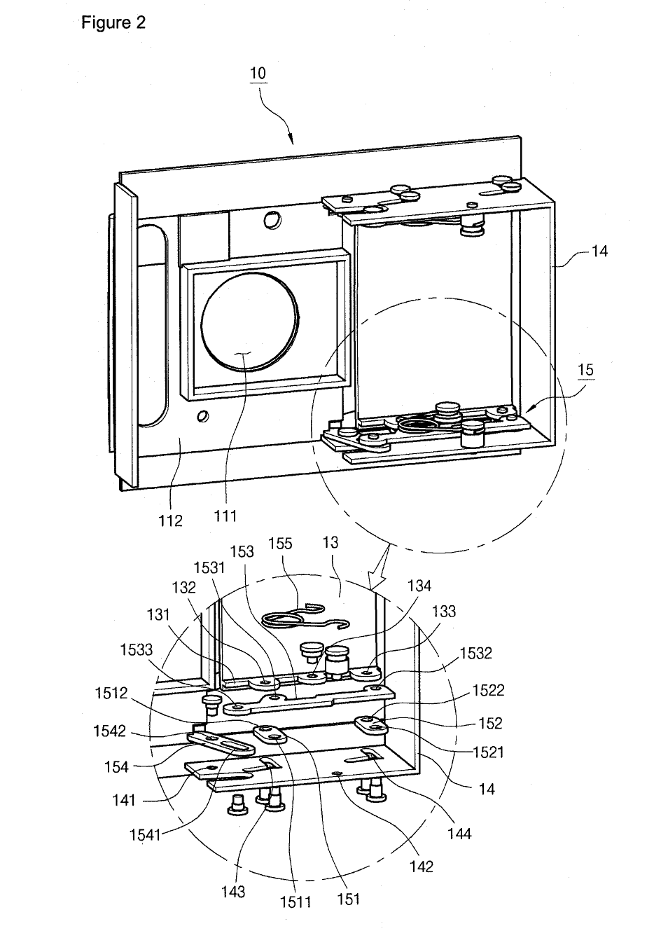

As illustrated in FIGS. 1 to 6, a connection hole 141 and a fixing hole 142 are diagonally formed in each side surface of the support frame 14 to connect the drive unit 15 to the support frame 14 by the medium of pins (refer to FIG. 2). First and second movement guide holes 143 and 144 are formed on opposite side surfaces of the support frame 14 so that the first and second connection holes 132 and 133 of the connection pieces 131 and the first and second connection links 151 and 152 of the drive unit are connected to each other by the medium of pins and the drive unit 15 is moved forward inside the support frame 14 when the plate member 13 is inserted into the support frame 14.

The first and second movement guide holes 143 and 144 have substantially L-shaped cross-sections, and the front sides of their horizontally punched portions are downwardly inclined so that the drive unit 15 can be moved more easily.

The drive unit 15 is operated when the rotary link 154 caught and rotated by slide movement of the cover member 12 is rotated to move the plate member 13 downward and to automatically return the plate member 13 when the cover member 12 slidably returns to the original position.

The drive unit 15 includes first and second connection links 151 and 152 movable on opposite inner surfaces of the support frame 14 along first and second movement guide holes 143 and 144, and having connection holes 1512 and 1522 at ends thereof so as to be connected to first and second connection holes 132 and 133 formed in the extension pieces 131 of the plate member 13 and having rotation holes 1511 and 1521 at the opposite ends thereof so as to be connected to movable bars 153 by the medium of pins, movable bars 153 in which holes 1531 and 1532 rotatably connected to the rotation holes 1512 and 1522 formed in the first and second links 151 and 152 by the medium of pins are spaced apart by a predetermined distance and movement holes 1533 is connected to ends of rotary links 154 through pins at the front ends thereof, rotary links 154 ends of which are rotatably connected to the movement holes 1533 by the medium of pins using holes 1541 and the opposite ends of which are rotatably connected to the connection holes 141 formed in the support frame 14 using rotation holes 1542 and protrude further than the support frame 14 so as to be caught so that the cover member 12 is slid, and resilient members 155 ends of which are connected to the extension pieces 131 of the plate member 13 and the opposite ends of which are connected to fixing holes 142 formed on side surfaces of the support frame 14 to provide a resilient force to the plate member 13 and automatically return the plate member 13. The resilient members 155 are torsion springs whose central portions are wound. The holes 1541 of the rotary links 154 are elliptical holes for moving the movement bars 153 by the operation of the drive unit 15.

Hereinafter, the operation of the safeguard apparatus for a camera lens according to one embodiment of the present invention will be described in detail with reference to FIGS. 1 to 6. As illustrated, when the user is to photograph a subject using a camera of a mobile phone, if the user pushes the cover member 12 covering the camera lens in one direction, i.e. downward as illustrated in FIG. 5, the cover plate 122 of the cover member 12 is slid along the guide bars 121 whereby the camera lens is exposed to the outside and the rotary link 154 of the drive unit 15 provided in the support frame 14 moves.

The rotation of the rotary link 154 operates the drive unit 15 whereby the plate member 13 provided at the rear end of the cover member 12 is moved downward inside the support frame 14. In other words, the rotation of the rotary link 154 moves the movable bars 153 ends of which are rotatably connected to the holes 1541 to the front side of the support frame 14 whereby the first and second links 151 and 152 ends of which are rotatably connected to the holes 1531 and 1532 of the movable bars 153.

The rotation of the first and second connection links 151 and 152 accommodates the plate member 13 connected through the first and second connection holes 132 and 133 formed in the extension pieces 131 by pins downward and to the front side toward the support frame 14 along the first and second movement guide holes 143 and 144 of the support frame 14.

Then, the resilient members 155 of the drive unit 15 are maintained compressed as the plate member 13 is moved downward and to the front side. In this state, i.e. with the camera lens being exposed as illustrated in FIG. 6, the subject is photographed using the camera provided in the mobile phone.

On the other hand, if the use of the camera is completed and the cover member 12 is slid to protect the camera lens, the drive unit 15 and the plate member 13 return to the original position by the forces of the compressed resilient members 155. In other words, if the resilient members 155 provide a resilient force to the plate member 13 as the cover member 12 is slid when the rotary link 15 is rotated by the cover member 12 and is caught by the bottom surface of the cover member 12, the plate member 13 is moved to the rear side and upward on opposite side surfaces of the support frame 14 along the first and second movement guide holes 143 and 144. As the plate member 13 moves, the movable bars 153 also moves, and the rotary link 154 rotates and returns.

According to the safeguard apparatus for a camera lens according to one embodiment of the present invention, since the user can open and close the lens by manipulating the cover member once, the lens can be simply and easily opened and closed.

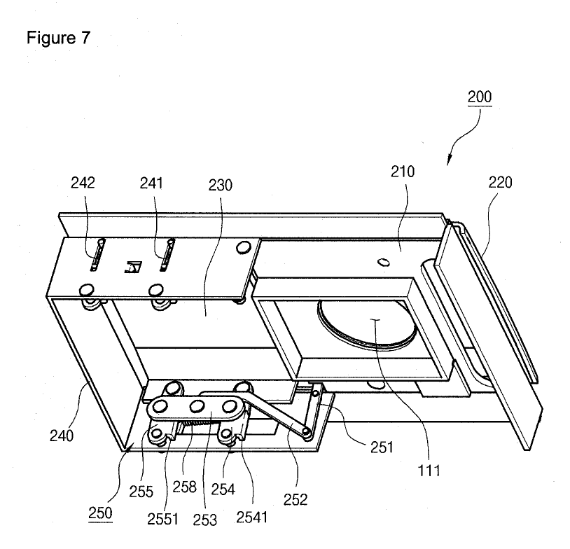

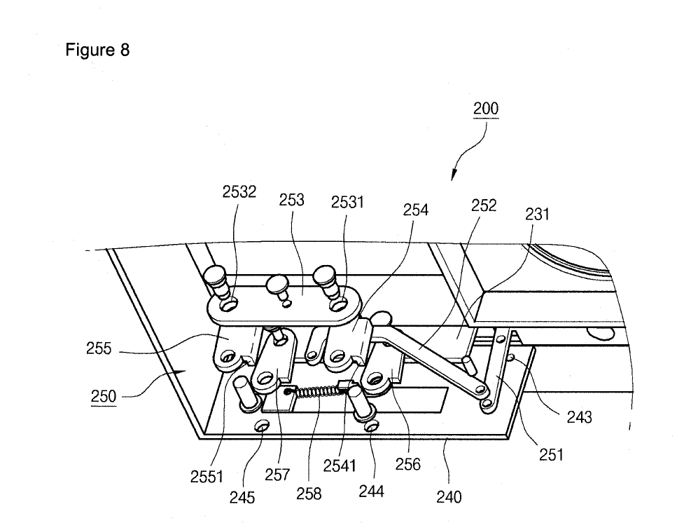

FIGS. 7 to 10 are views illustrating a safeguard apparatus for a camera lens according to one embodiment of the present invention. As illustrated, the safeguard apparatus 200 includes a support body 210 fixed to a case of a mobile phone and having a lens hole for exposing the camera lens, a cover member 220 slidably mounted to the support member 210 to open and close the camera lens exposed through the lens hole; a plate member 230 movable upward and downward from the rear end of the support body 210 while the cover member 220 is being slid; and a drive unit 250 provided in a support frame 240 to be operated by a rotary bar 252 rotated when the cover member 220 is slid, so as to accommodate and automatically return the plate member 230.

In the following descriptions, since the support body 210, the cover member 220, and the plate member 230 have the same or similar structures to those of one embodiment of the present invention, detailed descriptions thereof will be omitted.

As illustrated in FIG. 7, the upper and lower surfaces and one surface of the support frame 240 are opened, the support frame 240 is fixed to opposite side surfaces of the plate member 230 by pins and is spaced apart from the opposite side surfaces of the plate member 230, and a pair of longitudinal holes 241 and 242 are formed on opposite side surfaces of the support frame 240 respectively so that the plate member 230 is moved downward and inserted when the cover member 230 is slid by the operation of the drive unit 250.

Rotary bar holes 243 for rotatably connecting the rotary bars 251 of the drive unit 250 by the medium of pins are formed on the front side of the opposite side surfaces of the support frame 240, and a pair of hinge holes 244 and 245 for the operation of the drive unit 250 are formed on the opposite side surfaces of the support frame 240 and are separated from the longitudinal holes 241 and 242.

The drive unit 250 is operated by the rotation of the rotary bar 251 caught and rotated by slide of the cover member 220 to move the plate member 230 downward and automatically return the plate member 230 when the cover 220 slides and returns.

The drive unit 250 includes rotary bars 251 whose central upper ends are rotatably provided in the rotary bar holes 243 by the medium of pins and protruding further than opposite side surfaces of the support frame 240 so as to be caught and rotated when the cover member 220 is slid, rotational force transfer bars 252 ends of which are rotatably connected to ends of the rotary bars 251 respectively to transfer a rotational force, connection plates 253 rotatably connected to the opposite ends of the rotational force transfer bars 252 respectively and having connection holes 2531 and 2532 at opposite side ends thereof respectively, first and second rotary pieces 254 and 255 ends of which are rotatably connected to the connection plates 252 respectively and the opposite ends of which are rotatably connected to hinge holes 244 and 245 formed in the support frame 240, first and second movable pieces 256 and 257 ends of which are rotatably connected to the bottom surfaces of the opposite ends of the first and second rotary pieces 254 and 255 and the opposite ends of which are provided in the longitudinal holes 241 and 242 of the support frame 240 so as to be movable upward and downward, and resilient members 258 caught by pins so that ends thereof are fixed to opposite inner surfaces of the support frame 240 and the opposite ends thereof are connected to ends of the first movable pieces 256, the opposite ends of the first rotary pieces 254, or both ends of the connection plates (the right side of the connection plates illustrated in FIGS. 7 to 10), to return the connection plates 253, the first and second rotary pieces 254 and 255, and the first and second movable pieces 256 and 257 that are rotatably provided so as to correspond to the rotation of the rotary bars 251. Here, the resilient members 258 are tensile springs.

Catching bosses 2541 and 2551 bent downward to catch the first and second movable pieces 256 and 257 when the first and second rotary pieces 254 and 255 are rotated and returned as illustrated in FIGS. 7 to 10 are formed on side surfaces of the first and second rotary pieces 254 and 255.

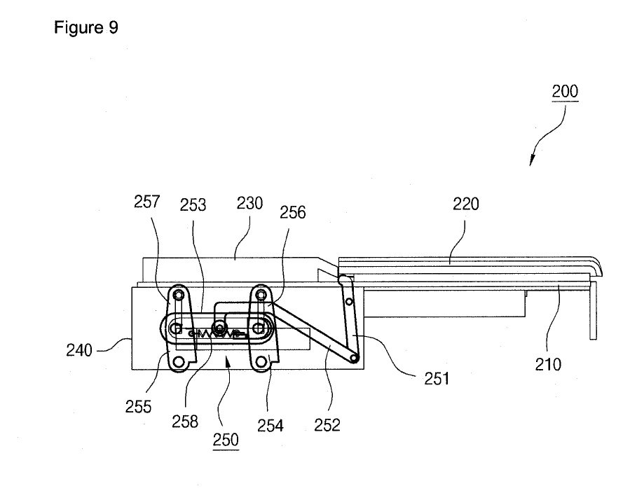

Hereinafter, the operation of the safeguard apparatus for a camera lens according to one embodiment of the present invention will be described with reference to FIGS. 7 to 10. As illustrated, when the user is to photograph a subject using a camera of a mobile phone, if the user pushes the cover member 220 covering the camera lens in one direction, i.e. downward as illustrated in FIG. 9, the cover member 220 is slid whereby the camera lens is exposed to the outside and the rotary links 251 of the drive unit 250 provided in the support frame 240 rotates.

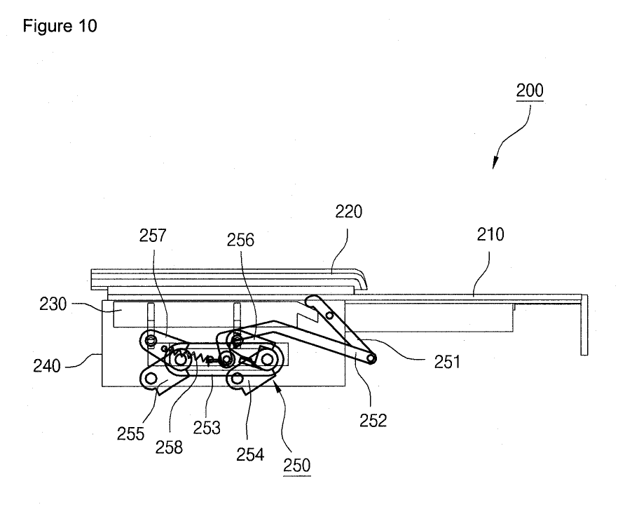

The drive unit 250 is operated by the rotation of the rotary bars 251 whereby the plate member 230 provided at the rear end of the cover member 220 is moved downward inside the support frame 240. In other words, if the rotary bars 251 are rotated, the rotational force transfer bars 252 ends of which are rotatably connected to the rotary bars 251 are rotated and are moved to the front side as illustrated in FIG. 10.

The rotation of the rotational force transfer bars 252 moves the connection plates 253 to the front side of the support frame 240 and rotates the first and second rotary pieces 254 and 255 and the first and second movable pieces 256 and 257 connected to the connection plates 253 by pins. At the same time, the plate member 230 is moved inside the support frame 240 along the longitudinal hole 241 and 242 of the support frame 240.

Then, as illustrated in FIG. 10, as the resilient members 258 of the drive unit 250 are maintained prolonged, if the use of the camera is completed and the cover member 220 is slid, the drive unit 250 and the plate member 230 of the resilient member 258 returns to the original state, in which case since the description of the restoration is similar to that of the foregoing embodiment of the present invention, a detailed description thereof will be omitted.

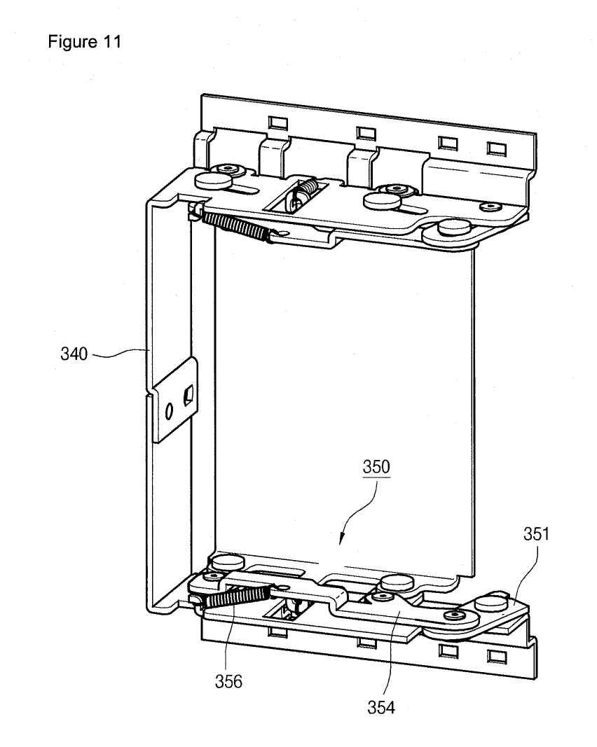

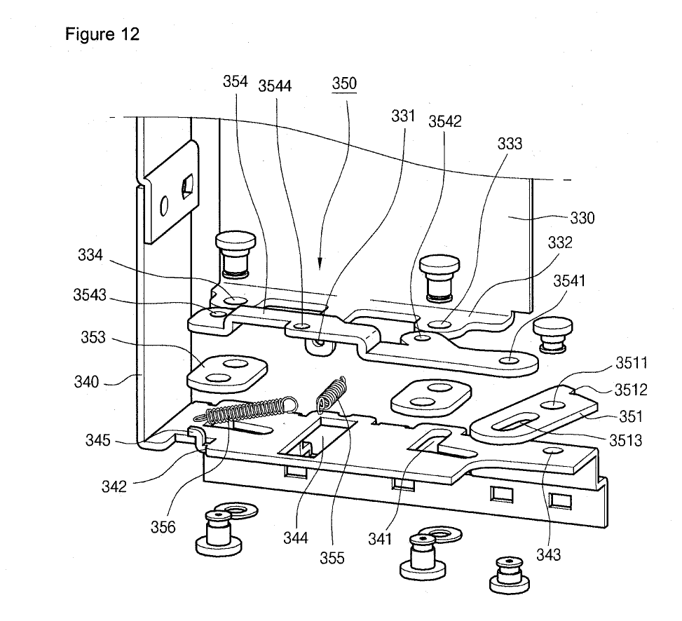

FIGS. 11 to 14 are views illustrating a safeguard apparatus for a camera lens according to one embodiment of the present invention. As illustrated, the safeguard apparatus 300 includes a support body 310 having a lens hole for exposing the camera lens, a cover member 320 slidably mounted to the support member 310 to open and close the camera lens exposed through the lens hole, a plate member 330 moved downward to automatically return to the original position by connecting one end of one of resilient members of a drive unit 350 to a connection hole 331 at the rear end of the support body 310 when the cover member 320 is slid, and a drive unit 350 provided in a support frame 340 to be operated by a rotary plate 351 rotated when the cover member 320 is slid, so as to accommodate and automatically return the plate member 330.

In the following descriptions, since the support body 310, the cover member 320, and the plate member 330 have the same or similar structures to those of the above discussed embodiments of the present invention, detailed descriptions thereof will be omitted.

As illustrated in FIGS. 11 to 14, the upper and lower surfaces and one surface of the support frame 340 of the safeguard apparatus 300 for a camera lens according to the embodiment of the present invention are opened to form a substantially U-like shape, opposite side surfaces of the plate member 330 are fixed to opposite side surfaces of the support frame 340 by pins, and first and second substantially L-shaped movement holes 341 and 342 are formed such that the plate member 330 is moved downward when the cover member 320 is slid.

Rotary plate holes 343 are formed on the front side of opposite side surfaces of the support frame 340 to rotatably connect the rotary plate 351 of the drive unit 350 by the medium of a pin and an accommodation hole 344 for accommodating first resilient members 355 of the drive unit 350 caught by the support frame 340 are formed between the movement holes 341 and 342.

Catching bosses 345 for catching ends of resilient members of the drive unit 350 are integrally bent on the bottom surfaces of opposite sides of the support frame 340. The drive unit 350 is operated by the rotation of the rotary plate 351 caught and rotated by slide of the cover member 320 to move the plate member 330 downward and automatically return the plate member 330 when the cover member 320 slidably returns.

The drive unit 350 includes rotary plates 351 having holes 3511 so that their central upper ends are rotatably connected to the rotary plate holes 343 by the medium of pins, ends of which are protrude further than opposite side surfaces of the support frame 340 so that catching bosses 3512 are integrally formed to be caught when the cover member 320 is slid rearward, and having holes 3513 at the lower ends of the holes 3511, rotational force transfer bars 354 in which a hole 3521 is formed at ends thereof so that the ends thereof are rotatably connected to the rotary plates 351 to transfer a rotational force, holes 3542 and 3543 are formed at the rear end and the opposite end of the hole 3521 so as to be connected to holes 333 and 334 formed in extension plates 332 of the plate member 330 and be connected to movement holes 341 and 342 formed in the opposite ends of the first and second connection plate 352 and 353 ends of which is rotatably connected by pins and the support frame 340, and catching holes 3544 for catching ends of the second resilient members 356 are formed between the holes 3542 and 3543, first resilient members 355 ends of which are caught by connection holes 331 of the plate member 330 located in accommodation holes 344 formed in the support frame 340 by connecting the plate member 330 to the support frame 340 and the opposite ends of which are caught by a support frame 340 to automatically return the plate member 330, and second resilient members 356 ends of which are caught by the catching bosses 345 of the support frame 340 and the opposite ends of which are caught by the catching holes 3544 of the rotational force transfer bars 354 to automatically return the drive unit 350. Here, the first and second resilient members 355 are tensile springs.

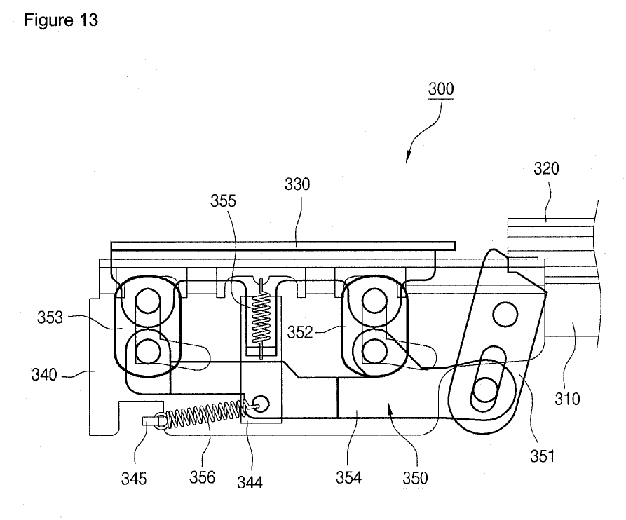

Hereinafter, the operation of the safeguard apparatus for a camera lens according to one embodiment of the present invention will be described with reference to FIGS. 11 to 14. As illustrated, when the user is to photograph a subject using a camera of a mobile phone, if the user pushes the cover member 320 covering the camera lens in one direction, i.e. downward as illustrated in FIG. 13, the cover member 320 is slid whereby the camera lens is exposed to the outside and the rotary plates 351 of the drive unit 350 provided in the support frame 340 rotates.

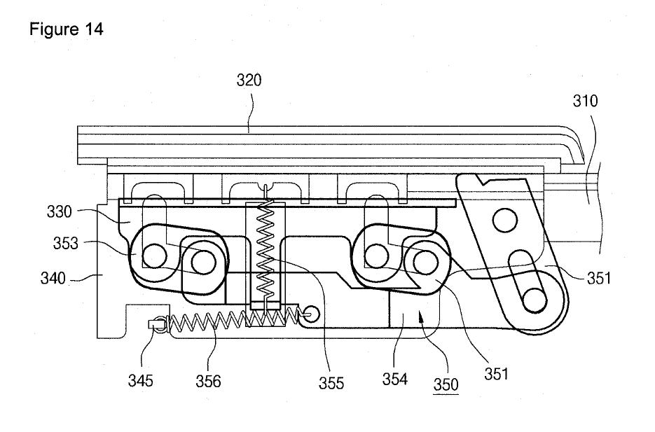

The drive unit 350 is operated by the rotation of the rotary plates 351 whereby the plate member 330 provided at the rear end of the cover member 320 is moved downward inside the support frame 340. In other words, if the rotary bars 351 are rotated, the rotational force transfer bars 354 ends of which are rotatably connected to the rotary plates 351 are rotated and are moved to the front side as illustrated in FIG. 14.

The first and second connection plates 352 and 353 are moved to the front side of the movement holes 341 and 342 formed on opposite side surfaces of the support frame 340 by the rotation of the rotational force transfer bars 354 and the plate member 330 is moved inside the support frame 340 along the movement holes 341 and 342 by the extension pieces 332 connected to the opposite ends of the first and second connection plates 352 and 352 by pins to open the lens.

Then, the first resilient members 355 of the drive unit ends of which are caught by the movement holes 331 of the plate member 330 and the opposite ends of which are caught by opposite side surface of the support frame 340 and the second resilient members 356 ends of which are caught by the catching bosses 345 of the support frame 340 and the opposite ends of which are caught by the catching holes 3544 of the rotational force transfer bars 354 are maintained prolonged as illustrated in FIG. 14, whereby if the cover member 320 is slid after use of the camera is completed, the operation unit 350 and the plate member 330 returns to the original state by the first and second resilient members 355 and 356, in which case since the description of the restoration is similar to those of the above discussed embodiments of the present invention, a detailed description thereof will be omitted.

Although embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A handheld electronic device, comprising:
a housing comprising a hole;
a camera lens accommodated within the housing and exposed through the hole;
a slidable panel slidable relative to the housing between a covering position and a uncovering position, wherein the camera lens is covered by the slidable panel when the slidable panel is at the covering position, wherein the camera lens is uncovered when the slidable panel is at uncovering position;
a retractable panel movable relative to the housing between a retracted position and an unretracted position; and
a mechanism configured to move the retractable panel from the unretracted position to the retracted position as the slidable panel slides from the covering position to the uncovering position.

2. The device of claim 1, wherein the retractable panel is at its unretracted position when the slidable panel is at its covering position.

3. The device of claim 1, wherein when the slidable panel is at its covering position and the retractable panel is at its unretracted position, the slidable panel and retractable panel are next to each other at about the same level from the housing.

4. The device of claim 1, wherein the retractable panel is at its retracted position when the slidable panel is at its uncovering position.

5. The device of claim 1, wherein when the slidable panel is at its uncovering position and the retractable panel is at its retracted position, the slidable panel and retractable panel are next to each other at different levels from the housing.

6. The device of claim 1, wherein the slidable panel covers the retractable panel when the slidable panel is at its uncovering position.

7. The device of claim 1, wherein the retractable panel is not covered by the slidable panel when the slidable panel is at its covering position.

8. The device of claim 1, wherein the mechanism comprises a lever configured to move between a first position and a second position, wherein the retractable panel is at its retracted position when the lever stays at the second position.

9. The device of claim 8, wherein the slidable panel is configured to move the lever from the first position to the second position as the slidable panel slides in an uncovering direction that is from the covering position to the uncovering position.

10. The device of claim 9, wherein the lever is configured to reach the second position before the slidable panel reaches the uncovering position during its sliding in the uncovering direction, wherein once the lever has reached the second position, the slidable panel causes the lever to stay at its second position while the slidable panel is sliding in the uncovering direction and when the slidable panel stays at its uncovering position.

11. The device of claim 8, wherein the lever is configured to move from the second position to the first position as the slidable panel slides in a covering direction that is from the uncovering position to the covering position.

12. The device of claim 11, wherein the sliding panel is configured to cause the lever to stay at its second position while the slidable panel is sliding in the covering direction until after the slidable panel has reached a predetermined position located between its covering position and its uncovering position.

13. The device of claim 12, wherein the mechanism comprises a spring that biases the lever toward its first position, wherein once the sliding panel has passed the predetermined position during its sliding in the covering direction, the lever is configured to begin moving from its second position to the first position.

14. The device of claim 13, wherein with action of the spring, the lever is further configured to push the sliding panel toward the covering position after the sliding panel has passed the predetermined position.

15. The device of claim 1, wherein the retractable panel is configured to reach its retracted position before the slidable panel reaches its uncovering position.

16. The device of claim 1, wherein the mechanism is further configured to move the retractable panel from the retracted position to the unretracted position as the slidable panel slides from the uncovering position to the covering position.

17. The device of claim 1, wherein the retractable panel is configured to stay at its retracted position until after the slidable panel has reached a predetermined position located between its covering position and its uncovering position.

18. A method of operating a handheld electronic device, the method comprising:
providing the device of claim 1, in which the slidable panel is at its covering position, and the retractable panel is at its unretracted position; and
sliding the slidable panel toward the uncovering position, which causes the retractable panel to move from the unretracted position toward the retracted position.

19. The method of claim 18, wherein the retractable panel reaches the retracted position before the slidable panel reaches the uncovering position, wherein the retractable panel stays at its retracted position when the slidable panel stays at its uncovering position.

20. The method of claim 19, further comprising:
sliding the slidable panel from the uncovering position toward the covering position, wherein the retractable panel stays at its retracted position before the slidable panel reaches a predetermined position between the uncovering position and the covering position; and
further sliding the slidable panel to pass the predetermined position, which causes the retractable panel to move from the retracted position to the unretracted position, and further causes the slidable panel to spontaneously slide toward the covering position without external force to slide the slidable panel toward the covering direction.
